(19) United States
(12) Patent Application Publication
(10) Pub. No.: US 2010/0116581 A1
(43) Pub. Date: May 13, 2010

(54) ROTARY VALVE FOR VEHICLE POWER STEERING GEAR

(75) Inventors: GANGCHUN XU, JILIN PROVINCE (CN); SHAOBO WANG, JILIN PROVINCE (CN); LIJUN LIU, JILIN PROVINCE (CN)

Correspondence Address: J C PATENTS, 4 VENTURE, SUITE 250, IRVINE, CA, 92618, US

(73) Assignee: CHANGCHUN HUALON AUTO-TECH CO., LTD, Jilin Province (CN)

(21) Appl. No.: 12/627,926

(22) Filed: Nov. 30, 2009

Related U.S. Application Data
(63) Continuation of application No. PCT/CN2007/002028, filed on Jun. 28, 2007.

(30) Foreign Application Priority Data
Jun. 1, 2007 (CN) 200710055708.7

(51) Int. Cl. B62D 5/083

(52) U.S. Cl. 180/429

(57) ABSTRACT

The present invention relates to a rotary valve for vehicle power steering gear, comprising a worm shaft, a lower sealing ring, a locking nut, a lower outer ring, an upper outer ring, an intermediate sealing ring, an upper sealing ring, an input shaft, a valve housing, steel balls, and an adjusting nut; wherein an outer ring bearing is disposed between the lower sealing ring and the intermediate sealing ring, or between the intermediate sealing ring and the upper sealing ring. The operational pressure of the power steering gear can be increased, thus allowing a higher pressure of the steering system to be selected in the configuration of the whole vehicle, so that a power steering gear with a relatively small volume can be selected, thereby making the configuration of the whole vehicle easier, and more compact.

### CROSS-REFERENCE TO RELATED APPLICATIONS

This application is a continuation of International Application No. PCT/CN2007/002028, filed on Jun. 28, 2007, which claims the priority benefit of Chinese Patent Application No. 200710055708.7, filed on Jun. 1, 2007. The contents of the above identified application are incorporated herein by reference in their entireties.

### FIELD OF THE TECHNOLOGY

The present invention relates to a rotary valve for vehicle power steering gear, belonging to the field of vehicle parts and components.

### BACKGROUND

At present, in a conventional vehicle power steering gear using an outer ring bearing, the outer ring bearing is either above the upper sealing ring, or below the lower sealing ring. Under the high-pressure oildraulic action, its worm shaft will exert a very large additional acting force to the outer ring bearing, with the additional acting force reducing the lifetime of the outer ring bearing. The higher the operational pressure is, the larger the additional acting force exerted by the worm shaft to the outer ring bearing is, and the shorter the lifetime of the outer ring bearing will be. Thus, the operational pressure of the power steering gear is limited.

### SUMMARY

The subject of the present invention is to provide a rotary valve for vehicle power steering gear, which eliminates the additional acting force exerted by the worm shaft to the outer ring bearing in the power steering gear due to the high-pressure oildraulic pressure, and allows the operational pressure of the power steering gear to be no longer limited by the additional acting force of the worm shaft to the outer ring bearing, thereby increasing the operational pressure of the power steering gear.

The technical solution of the present invention is achieved as follows: a rotary valve for vehicle power steering gear, comprising a worm shaft, a lower sealing ring, a locking nut, a lower outer ring, an upper outer ring, an intermediate sealing ring, an upper sealing ring, an input shaft, a valve housing, steel balls, and an adjusting nut; wherein the input shaft is inserted in the valve housing, the worm shaft is sleeved outside the input shaft, the lower outer ring and the upper outer ring are matched with each other and sleeved outside the worm shaft, the steel balls are embedded among the lower outer ring, the upper outer ring and the worm shaft, the worm shaft, the lower outer ring, the upper outer ring and the steel balls constitute an outer ring bearing, the adjusting nut is sleeved outside the worm shaft and matched with an inside wall of the valve housing to locate the outer ring bearing, the locking nut is sleeved outside the adjusting nut, the lower sealing ring, the intermediate sealing ring and the upper sealing ring are sleeved outside the worm shaft in sequence, and the outer ring bearing is disposed between the lower sealing ring and the intermediate sealing ring, or disposed between the intermediate sealing ring and the upper sealing ring.

An interior diameter of the lower sealing ring is d₁, an interior diameter of the intermediate sealing ring is d₃, and an interior diameter of the upper sealing is d₂, it is preferred when

$${d}_{1} = {d}_{2} = \frac{\sqrt{2}}{2} {d}_{3} .$$

The advantages of the present invention are that the operational pressure of the power steering gear can be increased, thus allowing a higher pressure of the steering system to be selected in the configuration of the whole vehicle, so that a power steering gear with a relatively small volume can be selected, thereby making the configuration of the whole vehicle easier, and more compact.

### BRIEF DESCRIPTION OF THE DRAWING

FIG. 1 is a schematic diagram of the structure of the present invention.

In the figure:

A-upper cavity of the steering gear

B-lower cavity of the steering gear

C-oil inlet port of the steering gear

D-oil return port of the steering gear

→ upward direction

### DETAILED DESCRIPTION

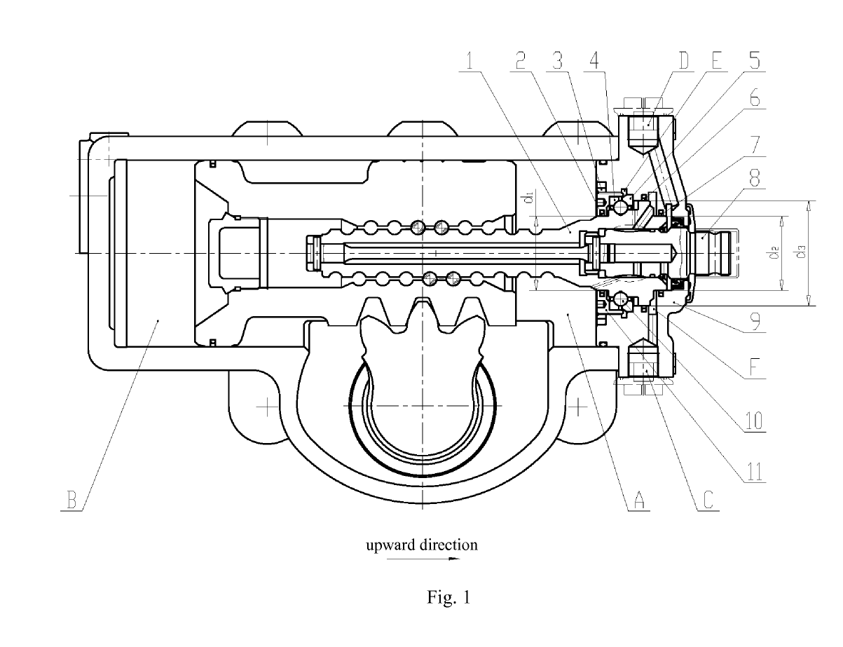

The present invention will be further described with reference to the drawing. As shown in FIG. 1, a rotary valve for vehicle power steering gear, comprising a worm shaft 1, a lower sealing ring 2, a locking nut 3, a lower outer ring 4, an upper outer ring 5, an intermediate sealing ring 6, an upper sealing ring 7, an input shaft 8, a valve housing 9, steel balls 10, and an adjusting nut 11. As shown in FIG. 1, the input shaft 8 is inserted in the valve housing 9. The worm shaft 1 is sleeved outside the input shaft 8. The lower outer ring 4 and the upper outer ring 5 are matched with each other and sleeved outside the worm shaft 1. The steel balls 10 are embedded among the lower outer ring 4, the upper outer ring 5 and the worm shaft 1. The worm shaft 1, the lower outer ring 4, the upper outer ring 5 and the steel balls 10 constitute an outer ring bearing. The adjusting nut 11 is sleeved outside the worm shaft 1 and matched with an inside wall of the valve housing 9 to locate the outer ring bearing. The locking nut 3 is sleeved outside the adjusting nut 11. The lower sealing ring 2, the intermediate sealing ring 6 and the upper sealing ring 7 are sleeved outside the worm shaft 1 in sequence. The outer ring bearing is disposed between the lower sealing ring 2 and the intermediate sealing ring 6, or disposed between the intermediate sealing ring 6 and the upper sealing ring 7. The positioning of the worm shaft 1 is carried out by the outer ring bearing consisting of the worm shaft 1, the lower outer ring 4, the upper outer ring 5 and the steel balls 10, with the force undergone by the worm shaft 1 acting on the outer ring bearing. The adjustment and positioning of the outer ring bearing is carried out by means of the adjusting nut 11. The locking of the adjusting nut 11 is carried out by means of the locking nut 3. The lower sealing ring 2 and the intermediate sealing ring 6 constitute an oil cavity E connected to a lower cavity of the steering gear (

$${S}_{lower} = \frac{π {d}_{3}^{2}}{4} - \frac{π {d}_{1}^{2}}{4} ,$$

where, S_{lower} represents the effective acting area of the oil cavity); and the intermediate sealing ring 6 and the upper sealing ring 7 constitute an oil cavity F connected to an oil inlet port C of the steering gear (

$${S}_{upper} = \frac{π {d}_{3}^{2}}{4} - \frac{π {d}_{2}^{2}}{4} ,$$

where, Sᵤₚₚₑᵣ represents the effective acting area of the oil cavity).

When the input shaft 8 is rotated, the oil pressure of an upper cavity A of the steering gear increases. At this moment, the oil pressure at the oil inlet port C of the steering gear is equal to that of the upper cavity A of the steering gear. The oil cavity E is in communication with the atmosphere via an oil return port D of the steering gear and a steering oil reservoir, with its pressure being neglected. The force undergone by the worm shaft 1 is analyzed as follows:

The force of the high-pressure oil in the oil cavity F acted downwards on the worm shaft 1 is:

F_{downwards}=S_{lower}×P.

The force of the high-pressure oil of the upper cavity A of the steering gear acted upwards on the worm shaft 1 is:

$${F}_{upwards} = \frac{π {d}_{1}^{2}}{4} \times P .$$

The total acting force undergone by the worm shaft 1 is:

$${F}_{total} = {F}_{upwards} - {F}_{downwards} = \frac{π {d}_{1}^{2}}{4} \times P - {S}_{lower} \times P$$

Where, P is the oil pressure, the interior diameter of the lower sealing ring is d₁, the interior diameter of the intermediate sealing ring is d₃, and the interior diameter of the upper sealing is d₂.

When d₁²=d₃²−d₂², Fₜₒₜₐₗ=0.

When the input shaft 8 is reversely rotated, the oil pressure of a lower cavity B of the steering gear increases. At this moment, the oil pressure of the oil cavity E is equal to that of the oil cavity E The upper cavity A of the steering gear is in communication with the atmosphere via the oil return port D of the steering gear and the steering oil reservoir, with its pressure being neglected. The force undergone by the worm shaft 1 is analyzed as follows:

The force of the high-pressure oil in the oil cavity F acted downwards on the worm shaft 1 is:

F_{downwards}=S_{lower}×P.

The force of the high-pressure oil in the oil cavity E acted upwards on the worm shaft 1 is:

F_{upwards}=Sᵤₚₚₑᵣ×P.

The total acting force undergone by the worm shaft 1 is:

Fₜₒₜₐₗ=F_{upwards}−F_{downwards}=Sᵤₚₚₑᵣ×P−S_{lower}×P

Where, P is the oil pressure.

When d₁=d₂, F_{upwards}=F_{downwards}, that is, Fₜₒₜₐₗ=0.

It can be derived from above calculation that the sum of the additional axial acting forces undergone by the worm shaft 1 is 0, when

$${d}_{1} = {d}_{2} = \frac{\sqrt{2}}{2} {d}_{3} ,$$

and at this moment, the outer ring bearing does not undergone the additional acting force from the worm shaft 1; and when the above relation cannot be completely satisfied, some of the additional acting force from the worm shaft 1 undergone by the outer ring bearing can be decreased. In this way, the additional acting force acted on the outer ring bearing is effectively reduced, thereby increasing the operational pressure of the steering gear.

The present invention is applicable to circulating ball power steering gears.

What is claimed is:

1. A rotary valve for vehicle power steering gear, comprising a worm shaft (1), a lower sealing ring (2), a locking nut (3), a lower outer ring (4), an upper outer ring (5), an intermediate sealing ring (6), an upper sealing ring (7), an input shaft (8), a valve housing (9), steel balls (10), and an adjusting nut (11); and characterized in that the input shaft (8) is inserted in the valve housing (9), the worm shaft (1) is sleeved outside the input shaft (8), the lower outer ring (4) and the upper outer ring (5) are matched with each other and sleeved outside the worm shaft (1), the steel balls (10) are embedded among the lower outer ring (4), the upper outer ring (5) and the worm shaft (1), the worm shaft (1), the lower outer ring (4), the upper outer ring (5) and the steel balls (10) constitute an outer ring bearing, the adjusting nut (11) is sleeved outside the worm shaft (1) and matched with an inside wall of the valve housing (9) to locate the outer ring bearing, the locking nut (3) is sleeved outside the adjusting nut (11), the lower sealing ring (2), the intermediate sealing ring (6) and the upper sealing ring (7) are sleeved outside the worm shaft (1) in sequence, and the outer ring bearing is disposed between the lower sealing ring (2) and the intermediate sealing ring (6), or disposed between the intermediate sealing ring (6) and the upper sealing ring (7).

2. The rotary valve for vehicle power steering gear according to claim 1, characterized in that an interior diameter of the lower sealing ring is d₁, an interior diameter of the intermediate sealing ring is d₃, an interior diameter of the upper sealing is d₂, and
$${d}_{1} = {d}_{2} = \frac{\sqrt{2}}{2} {d}_{3} .$$
